(19) United States
(12) Patent Application Publication
(10) Pub. No.: US 2002/0107883 A1
(43) Pub. Date: Aug. 8, 2002

(54) Distributed visual communications content development method and system

(76) Inventor: Ofer Schneid, Ramat-Hasharon (IL)

Correspondence Address: Oleg F. Kaplun, Esq., Fay Kaplun & Marcin, LLP, 17th Floor, 100 Maiden Lane, New York, NY, 10038, US

(21) Appl. No.: 09/779,268

(22) Filed: Feb. 8, 2001

(51) Int. Cl. G06F 15/00

(52) U.S. Cl. 707/501.1

(57) ABSTRACT

An integrated creation and work flow system for creating visual content in a distributed environment using a network. The systems coordinates content conversion to an intermediate live format. A central integrated application server coordinates live content storage, printable content storage and a distributed, privileged-based live-content review revision and approval work flow. In one exemplary embodiment, the system coordinates live content file conversion into an output format and delivery to an output provider. In another exemplary embodiment, the system coordinates the privileged-based, live-content storage, creation, review and approval of localized variations of content.

### FIELD OF THE INVENTION

The present invention relates generally to methods, systems, articles of manufacture and memory structures for facilitating visual communications, content creation and work flow and more specifically to a method and apparatus for providing a distributed, server-based, live-format publishing content creation and workflow system using a communications network.

### BACKGROUND INFORMATION

Conventional systems used for designing, developing and managing the work flow of visual communications content in a distributed environment are inefficient and insufficiently integrated. A common product marketing brochure may be used to illustrate visual communications content. For example, people utilizing professional document creation and publishing tools such as QuarkXPress™ to develop visual business communications such as brochures in a distributed environment may experience considerable work flow inefficiencies in areas including cost, manpower, time to completion, error reduction and required resources.

For example, original content design and creation functions may be performed at a first office or site while management and/or approval functions are performed at a second office remote from the first office. In such situations, at least two work flow methods are currently followed.

According to the first of these work flow methods, a QuarkXPress™ operator at the first office may create a brochure file and send it to a proof producing company (e.g., Iris Graphics) to have a proof made. The operator may then physically ship the proof to the second office for review. The proof is then reviewed and manually revised. This revised proof is then sent back to the first office to implement the revisions. This process is repeated until a final version of the brochure is approved. The review iterations may take place using other communications methods such as telephone, email, facsimile transmission and review using the Internet. In such a scenario, proof generation causes a time bottleneck that can add many days and the cost of multiple iterations is an additional inefficiency. Similarly, the communications methods described may be error prone, further increasing the cost and time required to generate the final product.

In the second work flow method, a QuarkXPress™ operator may create a brochure file and send the native file electronically or by mail on media to a second office having a copy of QuarkXPress™ and an operator who reviews the file and/or generates copies which may be reviewed by the personnel at the second office. After review, the required changes may be made to the file which is then sent back to the first office. In such a scenario, the second office and any additional offices involved must duplicate production requirements. Each remote office must have a copy of QuarkXPress™, a computer powerful enough to run the program, a high resolution display and an operator skilled in using QuarkXPress™.

Furthermore, each copy of QuarkXPress™ must have compatible fonts and tools installed—a requirement that the various installations be compatible. Problems may also arise where the second office does not utilize the same computing platform. Additionally, such a scenario does not allow for synchronization of the content or version control—the second office has the ability to change the entire file.

Companies having offices distributed geographically may wish to create localized versions of brochures in which certain portions of the master document are replaced locally with various translations or other regionally modified content. It may also be necessary to permit editing access only to those portions of a brochure that are to vary from location to location.

Companies may also wish to facilitate interaction with third-party design and creative agencies, printers and advertising companies. In this case, the problems associated with the incompatible of computer system can be more severe and more difficult to address.

Additionally, conventional systems may utilize several different data formats to transfer content data files. First, proprietary data formats may be utilized which provide for a “live” format in which each object in the content data file is parsed and modified using at least somewhat comprehensive tools that can modify each particular object. Secondly, systems may utilize “somewhat-live” formats in which certain objects are parsed and modified with a comprehensive tool set while other objects are not parsed or modified. Finally, systems may utilize “dead” formats such as bit-mapped image files in which the various objects of the original content file may not be parsed and/or modified.

### SUMMARY OF THE INVENTION

The present invention as illustrated in the disclosed exemplary embodiments provides an integrated creation and work flow system for creating visual content in a distributed environment using a network providing time and asset efficiencies. The systems coordinates content conversion to an intermediate live format. A central integrated application server coordinates live content storage, printable content storage and a distributed, privileged-based live-content review revision and approval work flow. In one exemplary embodiment, the system coordinates live content file conversion into an output format and delivery to an output provider. In another exemplary embodiment, the system coordinates the privileged-based, live-content storage, creation, review and approval of localized variations of content.

### BRIEF DESCRIPTION OF THE DRAWINGS

FIG. 1 shows a high level block diagram of a first exemplary embodiment of the present invention.

FIG. 2 shows a high level block diagram of a second exemplary embodiment of the present invention.

FIG. 3 shows a block diagram of data flow according to an exemplary embodiment of the present invention.

FIG. 4 shows a block diagram of document creation data flow according to an exemplary embodiment of the present invention.

FIG. 5 shows a block diagram of review and revision data flow according to an exemplary embodiment of the present invention.

FIG. 6 shows a block diagram of a document and data list linking data flow according to an exemplary embodiment of the present invention.

FIG. 7 shows a block diagram of a document commenting data flow according to an exemplary embodiment of the present invention.

FIG. 8 shows a block diagram of a document output data flow according to an exemplary embodiment of the present invention.

FIG. 9 shows a block diagram of intermediate live document creation data flow according to an exemplary embodiment of the present invention.

### DETAILED DESCRIPTION

As discussed more fully with reference to the following figures, the creation and editing work flow of publishing content is disclosed. For illustrative purposes, a desktop publishing (DTP) document is described as an example of the publishing content. This DTP is converted to an intermediate format by a plug-in on a DTP workstation including a desktop publishing software as is known in the art and automatically uploaded to a central server where it is stored. As is known in the art, the central server may be accessible to remote users via a communications network (e.g., the Internet), using, for example, a standard Java web browser. Utilizing, for example, Java technology, remote work flow users may review and alter the document only if granted access permissions. Work flow users may be granted various levels of permissions including, e.g., permission to assign permissions to other users. The central server may create proof and output ready versions of the document.

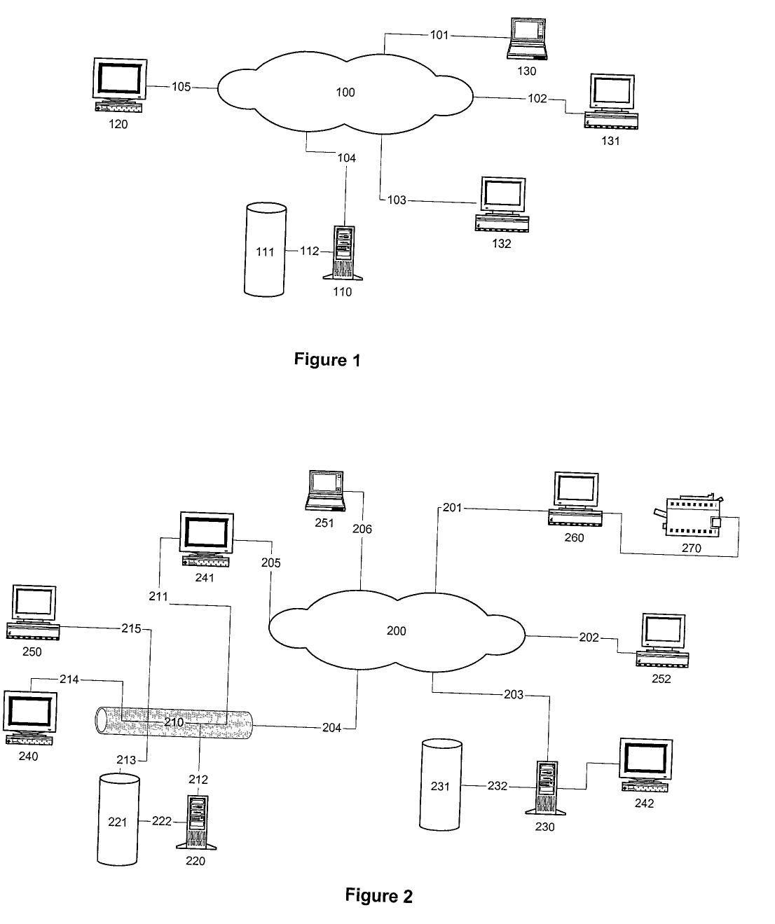

FIG. 1 shows a block diagram of a representative configuration of a first exemplary embodiment of the present invention, including a limited number of representative components for illustration. Particular implementations need not include all of the components illustrated except to the extent that the elements are described are necessary to the present invention. Those skilled in the art will understand that this representation is illustrative only and an integrated work flow publishing system according to the present invention may exist on a much larger scale with many more components that may be connected and disconnected at different times. Of course, a configuration having a single server and single remote work flow client is also possible.

Physical internetworking technology and data processing and storage technologies are well known in the art. The integrated work flow publishing system according to the present invention is designed to be flexible and may be implemented on a wide range of hardware and software systems and otherwise varied by those skilled in the art. In particular, well known scalability, reliability and security features may be utilized. Similarly, mixed computing platforms and networking environments are contemplated.

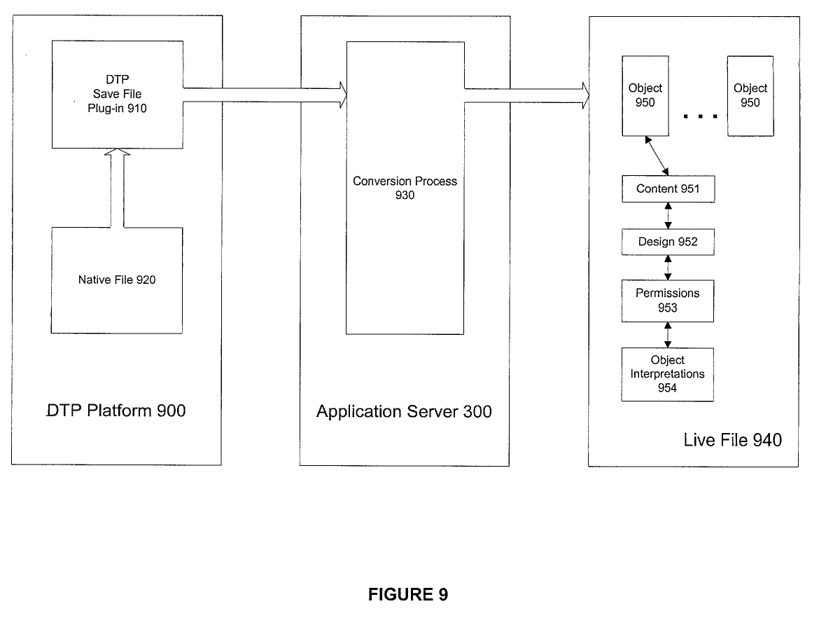

In the first exemplary embodiment, visual content is created using a DTP Workstation 120 which may be any visual content publishing application, including, but not limited to word-processing systems, drawing systems and Computer Aided Design systems. As described more fully below with reference to FIG. 9, data is sent to the Central Server 110-112 using distributed network 100 across communications connections 104-105. Central Server 110-112 is preferably an application server 110 and a storage server 111 interconnected by communications channel 112. Application and file servers are well known. Central Server 110-112 may include load balancing, distributed logical servers, clusters, or other known configurations. Physical internetworking technology is well known in the art. Network 100 is preferably the Internet, but may be any distributed network including an Ethernet LAN, PPP WAN or dial-up connections or any combination of these arrangements. Central Server 110-112 is preferably fault tolerant and preferably utilizes a common distributed file system such as NFS or CIFS.

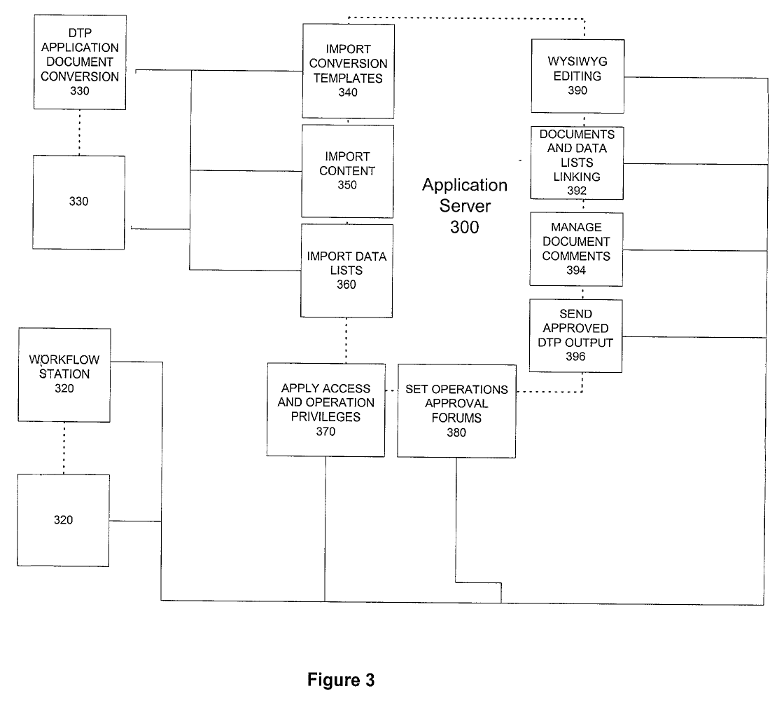

DTP Workstation 120 preferable executes plug-in file capture logic shown with reference to FIG. 9. Central Server 110-112 preferably executes file conversion and work flow logic described below with reference to FIGS. 3-8. As will be appreciated, the logic described may be executed on various data processors and/or distributed among a plurality of data processors. Furthermore, the logic may be implemented in software, firmware, hardware or any combination thereof. The DTP Workstation 120, Central Server 110-112 and work flow clients 130-132 are preferably IBM PC compatible computers, but may be implemented on any data processor including, but not limited to a Sun Microsystems computer, a cluster of computers, an embedded data processing system, a logical server configuration or any combination of platforms.

Remote work flow clients 130-132 are connected to the Central Server 110-112 using network 100 and connections 101-103. Network 100 can be any network, whether such network is operating under the Internet Protocol (IP) or otherwise. For example, network 100 may be, for example, a Point-to-Point (PPP) protocol connection or an X.25 network. Network 100 is preferably a Virtual Private Network (VPN) connection using TCP/IP across the Internet. Any connection 101-103 suitable to connect remote clients 1301-131 to network 100 may be utilized. Connection 101-103 is preferably a Plain Old Telephone Service (POTS) analog telephone line connection utilizing the PPP protocol. Connection 101-103 may also include other connection methods including ISDN, DSL, Cable Modem, leased line, T1, fiber connections, cellular, RF, satellite transceiver or any other type of wired or wireless data communications connection in addition to a network connection. Similarly, direct connections to the server are possible.

Physical file storage technologies are well known in the art. As will be appreciated by those skilled in the art, various file storage technologies may be utilized for a file server 111. For example, several physical computers or storage systems may be used. Logical file servers may be utilized as well with fault tolerance and load balancing. Similarly, a combination of native hosting and gateway hosting may also be utilized.

In this exemplary embodiment, Application server 110 utilizes Enterprise Java bean technology to execute the system logic described below with Java browsers at the clients 130-132. Of course many other technologies may be used including C++ and Perl programs.

FIG. 2 shows an exemplary embodiment utilizing components in addition to those of FIG. 1. This exemplary embodiment utilizes two Central Servers 220-222 and 230-232 connected to network 200 using connections 203, 204 and 210. DTP Workstations 240-242 are utilized and Work Flow clients 250-252 are included. The above components are preferably of the type described above, but may be varied as is well known in the art. FIG. 2 shows a print station 260 and proof and final printer 270 connected to network 260 using connections 201. As is understood by those skilled in the art, many print provider configurations may be utilized including, for example, a four color web press, a large format plotter, and ink-jet printer or a laser proof printer.

FIG. 3 illustrates the data flow and logic of an exemplary embodiment of the present invention. In this exemplary embodiment, a DTP user saves a native DTP file using QuarkXPress. The plug-in 330 sends this native DTP file to Application Server 300 where it is logged in. Import conversion template logic is executed to parse the document and to create an intermediate live version as shown below with reference to FIG. 9. Work flow clients 320 may add Access and Operation privileges using logic 370 and set up work flow operations and approval forums using logic 380. A wide variety of work flow procedures are known and any of those various work flow protocols may be implemented. Work flow clients 320 may review and comment on the DTP using comment logic 394. Similarly, work flow clients 320 may edit the intermediate file using WYSIWYG logic 390, preferably a fully live Java editor with comprehensive tools for each object. Finally, the Application server 300 and work flow clients 320 coordinate document and data linking using logic 392 and output using logic 396.

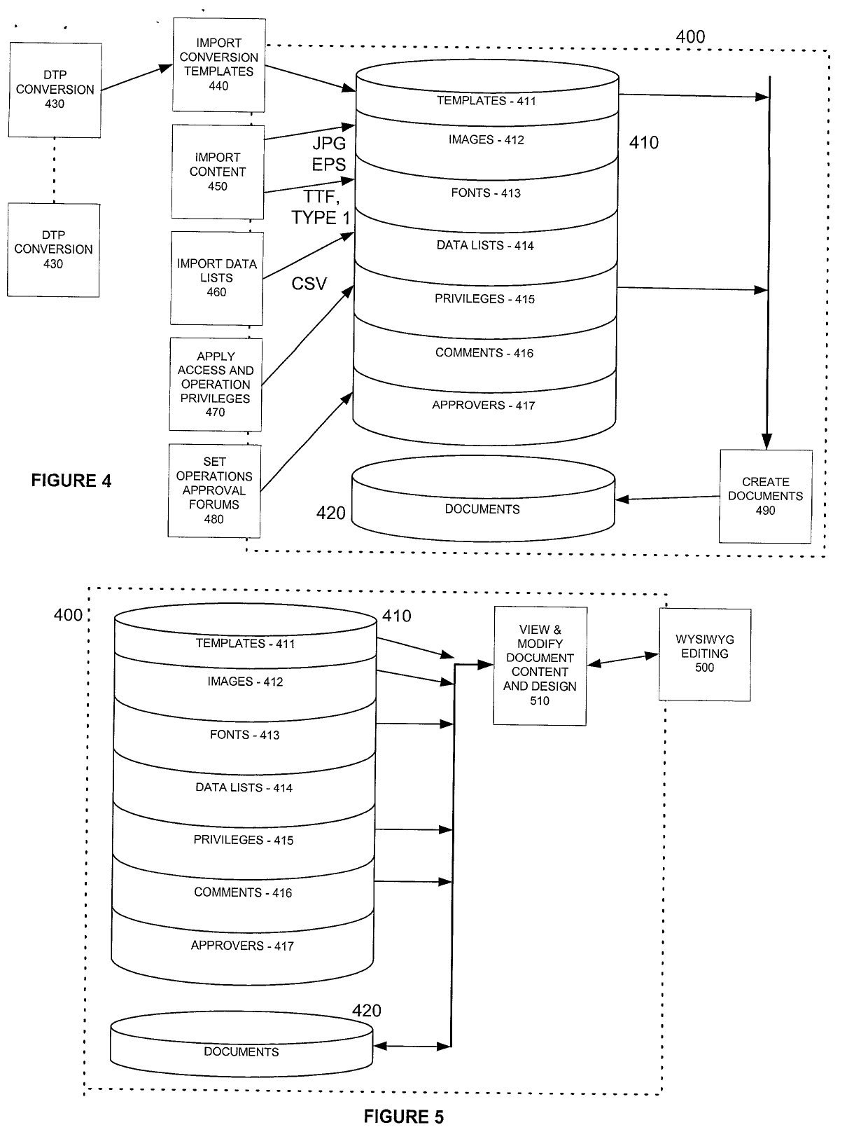

FIG. 4 shows the data flow of the conversion of this exemplary embodiment disclosed below with reference to FIG. 9. DTP conversion 430 sends a native DTP file to Application Server 400 where Import Conversion Templates and Logic 440 operate on the Templates object 411 for each converted file. The Import content logic 450 sends content such as JPG and EPS formatted content objects to the images object 412 and other data objects in TTF or Type 1 format to Fonts object 413. The Import Data Lists logic 460 parses CSV data to data lists object 414.

Similarly, other logic is executed at various times. The Access and operation privileges logic acts on the Privileges object 415 and the Set Approval forums logic 480 operates on the Approvers object 417.

Similarly, the create documents logic utilizes the templates object 411 and the privileges object 415 to create and store documents in the documents object 420. Any database may be used to store the various objects including, but not limited to an Oracle SQL database.

All of the logic described herein preferably operate as Component Object Modules (COMs), but Enterprise Java Beans (EJBs) or any other appropriate logic including hardware, software, firmware or any combination thereof may be used.

FIG. 5 shows the data flow of WSYIWYG review and editing logic of this exemplary embodiment. View and Modify logic 510 utilizes Templates object 411, images object 412, Fonts object 413, privileges object 415, comments object 416 and documents object 420 to interface with WYSIWYG logic 500. WYSIWYG logic 500 is preferably a Java client on a work flow client platform. The WYSIWYG logic preferably provides at least some editing capability for each object in the live intermediate file. However, the logic need not be as robust as the original DTP program for each object.

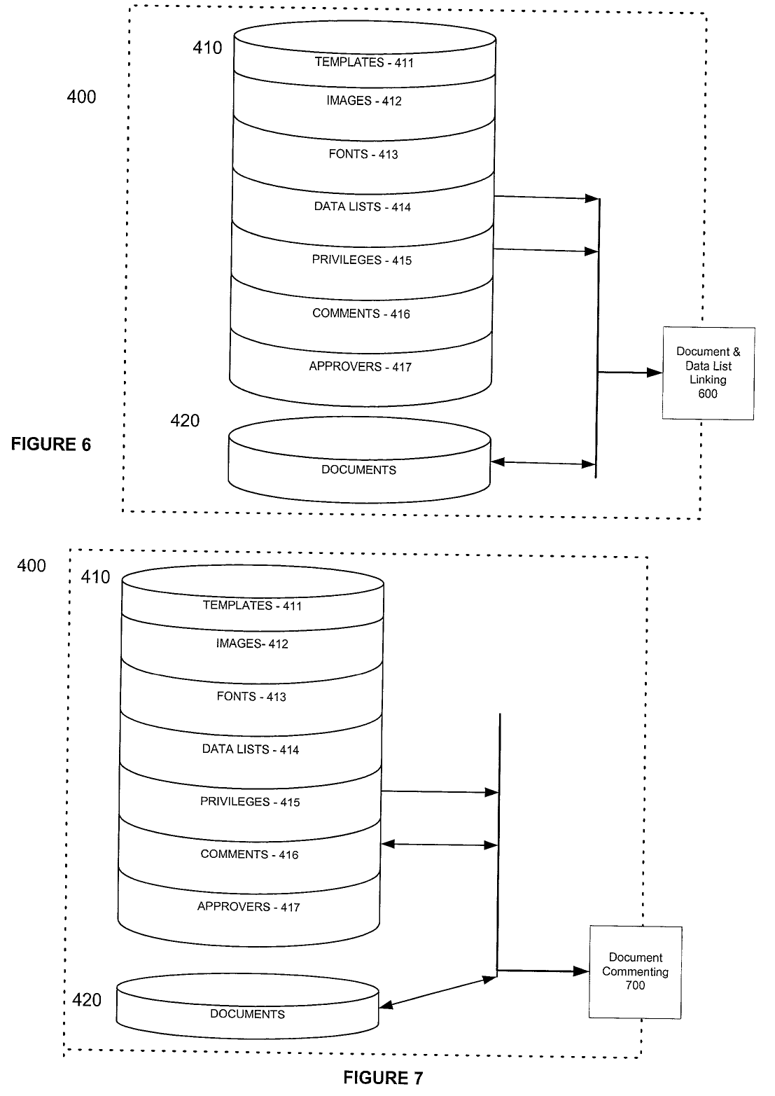

FIG. 6 shows the document and data list linking logic flow of this exemplary embodiment. Document and data list linking logic 600 utilizes Data Lists object 414, privileges object 415 and documents object 420 to allow localizations of various versions of the document. For instance, different translations may be manually or automatically applied to sections or objects of the content. The objects of the content that have been modified may be automatically determined using a style sheet or DTD or manually determined. Similarly, different graphics may be utilized in different regions. The localization functions are preferably executed using a Java interface to a work flow client.

FIG. 7 shows the comment logic flow of this exemplary embodiment. Comment logic 700 utilizes privileges object 415 to operate on comment subject 416 and documents object 420. Comments and versions are tracked for each document, each object of the document and for each version by user. The comment functions are preferably executed using a Java interface to a work flow client.

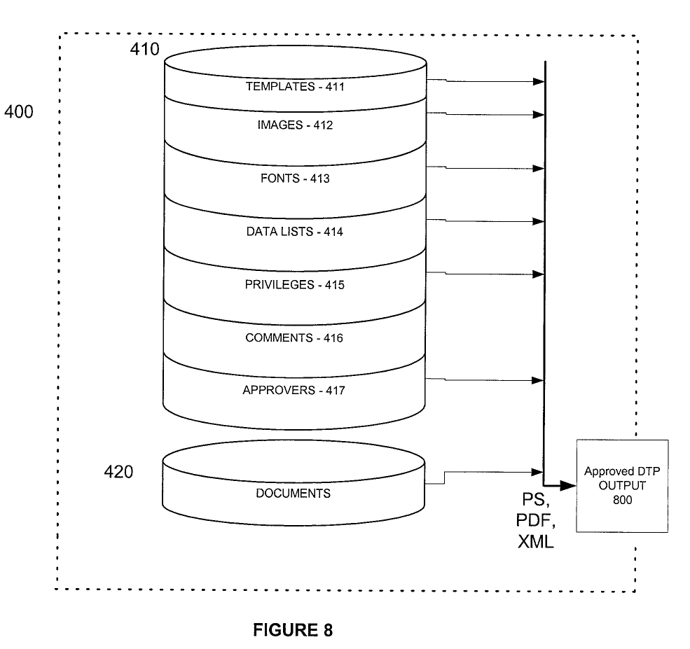

FIG. 8 shows the output logic flow. Output logic 800 utilizes Templates object 411, images object 412, Fonts object 413, data lists object 414, Privileges object 415, Approvers object 417 and documents object 420 to produce Output for proofs or final output, preferably in Postscript, Portable Document format or XML. The output functions are preferably controlled using a Java interface to a work flow client.

FIG. 9 shows conversion to the Intermediate Live file format. The DTP platform 900 saves a native file 920. The DTP plug-in 910 executes plug-in logic 910 to send the native file 920 to the Application Server 300. The conversion processor then parses the native file 920 into an XML Intermediate Live file 940 using conversion logic 930 and XML tags for each object type. Alternatively a DTD will define the object tag types available.

The conversion processor scans the native file 920 to detect each object 950 thereof and for each object 950, a content object is parsed and stored including a value of the type of content therein. Similarly, a design object 952 is parsed with location and format information and the interrelationships of each of the objects 950 and 952 are determined and stored in an object interrelation object 954. Similarly permissions object 953 may begin with standard permissions from a DTD or may be added by work flow clients.

As is understood by one of ordinary skill in the art, various data representations may be utilized in place of XML. For example, the various elements may be stored in SGML, a Structured Query Language (SQL) database or a flat file. Similarly, well known reliability and back-up procedures may be employed. The Standard Generalized Markup Language (SGML) and more specifically the subset of SGML known as the extensible Markup Language (XML) is preferably utilized. The current XML recommendation published by the World Wide Web Consortium (W3C) is entitled Extensible Markup Language (XML) 1.0 (Second Edition) and is incorporated herein by reference.

In a preferred exemplary embodiment, a user known as the program manager has program manager privileges and can determine the access privileges that each user may assert over each element of a visual business communication such as a brochure. For example, there may be several main offices with write privileges for only certain portions of particular visual business communications. A local office would likely have permission to view the entire file, but to change only the respective localization portion of the brochure. Similarly, the printer may be allowed read-only access. As understood by one of ordinary skill in the art, other permission schemes are possible. For example, users may belong to a group of users with certain privilege levels. Similarly, the permission may be based on properties of a particular element, such as whether it be text or graphic.

There are many modifications to the present invention which will be apparent to those skilled in the art without departing from the teaching of the present invention. The embodiments disclosed herein are for illustrative purposes only and are not intended to describe the bounds of the present invention which is to be limited only by the scope of the claims appended hereto.

What is claimed is:

1. A method for converting a publishing content data file to live intermediate data file, comprising the steps of:
receiving a publishing content data file in a native format from a publishing content creation application;
transmitting the publishing content data file to a conversion processor of a central server;
operating the conversion processor to analyze the publishing content data file to generate a template, the template including a plurality of editable identifiable objects;
saving the identifiable objects from the publishing content data file in a database of the central server; and
generating a live intermediate data file as a function of the template and the identifiable objects in a format editable without use of the publishing content creation application.

2. The method according to claim 1, wherein the transmitting step is performed via a communication network.

3. The method according to claim 1, wherein a first one of the identifiable objects includes at least one of a text and an image.

4. The method according to claim 3, wherein the first identifiable object includes data corresponding to its position within the publishing content data file.

5. The method according to claim 4, wherein the data corresponding to the position of the first identifiable object includes data corresponding to the position of the first identifiable object relative to a second one of the identifiable objects.

6. The method according to claim 3, wherein the first identifiable object includes data corresponding to a characteristic of a content of the first identifiable object.

7. The method according to claim 6, wherein the data corresponding to a characteristic of the first identifiable object includes data corresponding to at least one of color, font and spacing.

8. The method according to claim 6, wherein the first identifiable object includes an identifier indicating that the first identifiable object includes one of publishing data file content and comments on publishing data file content.

9. The method according to claim 6, wherein the first identifiable object includes data corresponding to at least one of user access privileges, user comment privileges, a relationship of the first identifiable object to a second one of the identifiable objects and identifiable object approval criteria.

10. The method according to claim 1, further comprising the step of displaying the live intermediate data file via a conventional web browser.

11. The method according to claim 1, further comprising the step of editing the live intermediate data file by editing the first identifiable object without utilizing the publishing content creation application.

12. The method according to claim 11, further comprising the step of tracking changes made to the first identifiable object.

13. The method according to claim 6, further comprising the steps of:
generating predetermined access privilege criteria for the first identifiable object; and
allowing access to the first identifiable object as a function of the privilege criteria.

14. A publishing system, comprising:
a data processor connected to a first computer via a network;
a storage device connected to the data processor, the storage device storing a logic program; and
an input device coupled to the data processor and to the network, the input device receiving from the first computer a publishing content data file in a native format created using a publishing content creation application, wherein the data processor receives the publishing content data file from the input device and analyzes the publishing contact data file to generate a template including a plurality of editable identifiable objects, the data processor storing the identifiable objects in the storage device and generating, as a function of the template and the identifiable objects, a live intermediate data file editable without using the publishing content creation software.

15. The publishing system according to claim 14, further comprising a second computer coupled to the data processor via the network, further comprising an output device coupled to the storage device and the network so that the live intermediate data file may be accessed by a user of the second computer to edit the live intermediate data file without using the publishing content creation application.

16. A computer-readable storage medium storing a set of instructions, the set of instructions capable of being executed by a processor, the set of instructions performing the steps of:
receiving a publishing content data file in a native format from a publishing content creation application;
transmitting the publishing content data file to a conversion processor of a central server;
operating the conversion processor to analyze the publishing content data file to generate a template, the template including a plurality of editable identifiable objects;
saving the identifiable objects from the publishing content data file in a database of the central server; and
generating a live intermediate data file as a function of the template and the identifiable objects in a format editable without use of the publishing content creation application.
